(19) United States
(12) Patent Application Publication
(10) Pub. No.: US 2016/0230250 A1
(43) Pub. Date: Aug. 11, 2016

(54) SEA WATER LITHIUM-RECOVERY DEVICE AND LITHIUM-RECOVERY STATION USING COASTAL-WATER-BASED LITHIUM-ADSORPTION EQUIPMENT AND SHORE-BASED LITHIUM-ISOLATION EQUIPMENT, AND LITHIUM DESORPTION DEVICE USING AERATION

(71) Applicant: KOREA INSTITUTE OF GEOSCIENCE AND MINERAL RESOURCE, Daejeon (KR)

(72) Inventors: Kang Sup Chung, Daejeon (KR); Byoung Gyu Kim, Daejeon (KR); Tae Gong Ryu, Daejeon (KR); Jung Ho Ryu, Daejeon (KR); In Su Park, Daejeon (KR); Hye Jin Hong, Daejeon (KR)

(21) Appl. No.: 15/021,668

(22) PCT Filed: Aug. 28, 2014
(86) PCT No.: PCT/KR2014/007990

§ 371 Date: Mar. 11, 2016

(30) Foreign Application Priority Data
Sep. 12, 2013 (KR) 10-2013-0109481
Sep. 30, 2013 (KR) 10-2013-0116206
Oct. 16, 2013 (KR) 10-2013-0123073

(51) Int. Cl. C22B 26/12; C02F 1/461; C25C 7/08; C25C 1/22; C25C 7/02; C22B 3/10; C02F 1/469

(52) U.S. Cl. CPC C22B 26/12; C22B 3/10; C02F 1/46109; C02F 1/4691; C25C 1/22; C25C 7/02; C25C 7/08; C02F 2001/46138; C02F 2103/08

(57) ABSTRACT

The present invention relates to a device for recovering lithium included in a solution such as sea water, and to a sea water lithium-recovery device and a lithium-recovery station using coastal-water-based lithium-adsorption equipment and shore-based lithium-isolation equipment and a lithium desorption device using aeration.

### TECHNICAL FIELD

The present invention relates to a device for recovering lithium included a solution such as sea water.

### BACKGROUND ART

A depletion problem of valuable metal mineral resources that is being issued recently is expected to hinder development of human civilization in the near future.

The yield of land lithium mineral resources with economy is only about 4,100,000 tons globally, and therefore the lithium mineral resources are scarce resources that will be depleted in the next 10 years.

The lithium resources excessively concentrate on some countries. Therefore, a method for mining lithium from an ore and a salt lake may not be applied realistically in Korea having an infinitesimal quantity of lithium reserves, and so on.

However, even though lithium is present in dissolved resources in sea water as a tiny quantity of 0.17 mg/L, it has been known that an overall dissolved quantity of lithium is considerable as 230 billion tons.

Therefore, a mineral-recovery technology capable of selectively extracting only specific valuable metal ions melted (dissolved) in sea water can lower overseas dependency for resources and stably supply resources, and as a result is a very important technology that has sufficient values as growth engine of the national economy and achieves the continuous development of the national economy.

Most of the related arts associated with a technology for recovering valuable metals from sea water have been developed, focusing on technologies for exchanging and adsorbing ions of inorganic or organic materials to selectively remove specific metal ions.

In particular, the valuable metals are generally recovered by a technology of embedding inorganic compound particles, such as manganese oxides, as a lithium ion molecular sieve in a polymer such as polyvinyl chloride (PVC) or storing them in a storage formed of a polymer membrane to selectively exchange ions and then perform acid treatment process.

The related arts as described above are advantageous in having a high recovery rate of lithium ion from sea water.

However, the related arts take much time to adsorb specific ions, and therefore have low economical efficiency and efficiency and the related arts need to use toxic materials such as acid in post-processing processes of recovering ions such as a process of isolating ions, and therefore cause a problem of corrosion of a system, environmental pollution, etc.

To solve the problem, Korean Patent No. 10-1136816 was proposed by the inventors of the present application.

The technology includes an electrode module to which metal ions such as lithium are adsorbed and moves a solution in which metal ions are present to the electrode module using a pump to adsorb lithium ion to the electrode module to which an electrode is applied.

Further, the technology may change polarity of the electrode to isolate lithium ion from the electrode module when intending to isolate the adsorbed lithium ion, thereby recovering lithium included in a solution such as sea water.

Meanwhile, the existing technology of recovering lithium from sea water is performed at deep sea owing to limited performance of an adsorbent, has big trouble in commercialization owing to enormous construction costs and operating costs of a system to recover lithium from sea water, has a short driving time because days of good weather conditions are rare, and has a safety problem due to typhoon, strong waves, etc.

### DISCLOSURE

### Technical Problem

An object of the present invention is to provide a sea water lithium-recovery device using coastal-water-based lithium-adsorption equipment and shore-based lithium-isolation equipment which has excellent economical efficiency and is less affected by weather conditions to have a long driving time and more excellent safety.

Another object of the present invention is to provide a lithium-recovery station capable of maximally reducing power required to recover lithium included in sea water.

Still another object of the present invention is to provide a lithium desorption device using aeration capable of easily increasing a reaction rate of acid solution with lithium manganese oxide even when a weight of the lithium manganese oxide is very heavy, during a process of desorbing lithium ion from the lithium manganese oxide by a reaction of the lithium manganese oxide and the acid solution, which are injected into an acid-resistant water bath, to generate the manganese oxide.

### Technical Solution

In one general aspect, a sea water lithium-recovery device using coastal-water-based lithium-adsorption equipment and shore-based lithium-isolation equipment includes: a lithium-adsorption means 70 positioned at a coast to adsorb lithium included in sea water; a lithium-isolation means 80 positioned at a shore or a land adjacent to the shore and isolating the lithium adsorbed to the lithium-adsorption means 70 to obtain the lithium; and an adsorbed lithium moving means 90 moving a portion to which the lithium is adsorbed in the lithium-adsorption means 70 to the lithium-isolation means 80 to supply the adsorbed lithium.

The adsorbed lithium moving means 90 may move a lithium adsorbent to which the lithium is adsorbed along a line and supply the lithium adsorbent to the lithium-isolation means 80.

In another general aspect, a sea water lithium-recovery device using coastal-water-based lithium-adsorption equipment and shore-based lithium-isolation equipment includes: a lithium-adsorption means 70 positioned at a coast to adsorb lithium included in sea water; a high-concentration lithium solution preparing means 85 positioned at the coast and isolating the lithium adsorbed to the lithium-adsorption means 70 to be a high-concentration lithium containing solution; a lithium-extraction means 86 positioned at a shore or a land adjacent to the shore and supplied with the high-concentration lithium solution obtained by the high-concentration lithium solution preparing means 85 to extract the lithium; and a lithium solution supply means 95 supplying the high-concentration lithium solution obtained by the high-concentration lithium solution preparing means 85 to the lithium-extraction means 86.

The lithium solution supply means 95 may include a supply pipe 95a connecting between the high-concentration lithium solution preparing means 85 and the lithium-extraction means 86 and a pump 95b supplying the high-concentration lithium solution to the supply pipe 95a.

The lithium-adsorption means 70 may include: a first electrode 10 having a carrier 11 of which the surface is coated with an adsorbent 12 including manganese oxide; a second electrode 20 dipped in the sea water including the lithium, disposed to face the first electrode 10 at a predetermined interval, and applied with electricity; and a power supplier applying electricity to the first electrode 10 and the second electrode 20 and applying a negative electrode (−electrode) and a positive electrode (+electrode) to the first electrode 10 and the second electrode 20, respectively.

In another general aspect, a lithium-recovery station 1000 includes: a floater 100 floating on the sea; a moving means 200 installed in the floater 100 to move a lithium adsorbent 110; an adsorption bath 300 installed in the floater 100, having a lower surface opened to contact with sea water to allow the lithium adsorbent 110 to adsorb lithium ion in the state in which the lithium adsorbent 110 is dipped in the sea water of a lower surface of the floater; a cage 310 coupled to the lower surface of the adsorption bath 300 and stacking the lithium adsorbent 110 in the state in which the lithium adsorbent 110 is dipped in the sea water; a washing bath 400 installed in the floater 100 and washing the lithium adsorbent 110 to which the lithium ion moving from the adsorption bath 300 by the moving means 200 is adsorbed; and a desorption bath 500 installed in the floater 100 and desorbing the lithium ion of the lithium adsorbent 110 to which the lithium ion moving in the washing bath 400 by the moving means 200 is adsorbed.

The floater 100 may further include: a washing solution storage tank storing a washing solution supplied to the washing bath 400 and a lithium desorption solution storage tank storing a lithium desorption solution desorbed in the desorption bath 500.

The floater 100 may further include: a lithium desorption solution transfer means for supplying a lithium desorption solution desorbed in the desorption bath 500 to the shore or the land adjacent to the shore.

The floater 100 may further include: a washing solution transfer means supplying the washing solution required for the washing bath 400 from the shore or the land adjacent to the shore.

The moving means 200 may include: a crane 210 installed in the floater 100; a chain 220 connected to the crane 210; and a frame 230 connected to the chain 220 and having the lithium adsorbent 110 received therein.

The lithium-recovery station 1000 may further include: a power generator 600 installed in the floater 100 and producing power using diesel power generation and solar heat and supplying the produced power to the crane 210.

The lithium-recovery station 1000 may further include: a support means 800 including a plurality of pillars 810 fixed to a sea ground positioned around the floater 100 and a plurality of connection ropes 820 connecting between the pillars 810 and the floater 100.

In another general aspect, a lithium-desorption device 2000 using aeration includes: a housing 1100 having an upper surface opened and having an acid solution stored therein; a lithium reaction body 1200 having an outer wall formed of a porous polymer membrane, having lithium manganese oxide stored therein, and inserted into the housing 1100 to desorb lithium ion from the lithium manganese oxide by a reaction of the lithium manganese oxide with the acid solution to generate the manganese oxide; and an aeration means 1300 including an air supply means 1310 installed at an outer side of the housing 1100, a first air pipe 1320 connected to the air supply means 1310 and installed in the housing 1100, a second air pipe 1330 connected to the first air pipe 1320 and provided with a perforation 1331 that is installed at a bottom surface inside the housing 1100 and has air injected into a surface thereof, and an aeration box 1340 installed in the housing 1100 and including a plurality of pores 1341 through which air transferred from the perforation 1331 is injected.

The aeration box 1340 may be installed in the housing 1100 in plural.

In the aeration means 1300, the perforation 1331 formed in the second air pipe 1330 may be wider than the pore 1341 formed in the aeration box 1340.

The lithium-desorption device 2000 using aeration may further include: an air duct 1400 including a top cover 1410 installed on an opened upper surface of the housing 1100, a blower 1420 penetrating through an upper surface of the top cover 1410 to suck lithium ion generated in the housing 1100, a support 1430 coupled to a lower end of a circumferential surface of the top cover 1410, and a wheel 1440 coupled to a lower end of the support 1430.

In another general aspect, a lithium-desorption method using a lithium-desorption device using aeration includes: a first process of inserting a lithium reaction body into a housing to desorb lithium ion from lithium manganese oxide by a reaction of the lithium manganese oxide stored in the lithium reaction body with acid solution to generate the manganese oxide and increasing a reaction rate of the lithium manganese oxide with the acid solution by air injected through pores of the aeration box; and a second process of inserting the lithium reaction body into sea water to adsorb lithium ion included in the sea water to the manganese oxide by a reaction of the manganese oxide generated in the first process with the sea water to again generate the lithium manganese oxide.

The lithium-desorption method may further include: a third process of again inserting the lithium manganese oxide generated in the second process into the housing to desorb the lithium ion from the lithium manganese oxide by the reaction of the lithium manganese oxide stored in the lithium reaction body with the acid solution to generate the manganese oxide and increasing the reaction rate of the lithium manganese oxide with the acid solution by air injected through the pores of the aeration box.

### Advantageous Effects

As set forth above, according to the exemplary embodiments of the present invention, the sea water lithium-recovery device using coastal-water-based lithium-adsorption equipment and shore-based lithium-isolation equipment may perform the process of adsorbing lithium from sea water at a coast having weather conditions relatively better than those at the ocean and may move the process of recovering the adsorbed lithium to the equipment at the coast to perform the process of recovering the adsorbed lithium, thereby making the economical efficiency more excellent, making the driving time longer due to the less effect of weather conditions, and making the safety more excellent.

Further, according to the exemplary embodiments of the present invention, the sea water lithium-recovery device using coastal-water-based lithium-adsorption equipment and shore-based lithium-isolation equipment, the adsorbed lithium moving means may be implemented to move the lithium adsorbent such as the electrode to which lithium is adsorbed along the line and supply the lithium adsorbent to the lithium-isolation means, thereby minimizing the number of processes performed on the sea.

Further, according to the exemplary embodiments of the present invention, the sea water lithium-recovery device using coastal-water-based lithium-adsorption equipment and shore-based lithium-isolation equipment may prepare the high-concentration lithium solution at the coast and supply the prepared solution to the shore through the supply pipe and the pump to extract lithium, thereby facilitating the installation of the supply pipe when the topography from the coast to the shore is flat and making the economical efficiency excellent.

According to the exemplary embodiment of the present invention, the lithium-recovery station may include: a floater floating on the sea; a moving means installed in the floater to move a lithium adsorbent; an adsorption bath installed in the floater, having a lower surface opened to contact with sea water, and adsorbing lithium ion in the state in which the lithium adsorbent is dipped in the sea water of a lower surface of the floater; a cage coupled to the lower surface of the adsorption bath and stacking the lithium adsorbent in the state in which the lithium adsorbent is dipped in the sea water; a washing bath installed in the floater and washing the lithium adsorbent to which the lithium ion moving in the adsorption bath by the moving means is adsorbed; and a desorption bath installed in the floater and desorbing the lithium ion of the lithium adsorbent to which the lithium ion moving in the washing bath by the moving means is adsorbed, thereby removing the power for introducing the sea water to maximally reduce the necessity of power required to recover the lithium included in the sea water .

According to the exemplary embodiment of the present invention, the lithium-desorption device using aeration may inject air to the acid solution and the lithium manganese oxide using the aeration even when the weight of the lithium manganese oxide is very heavy, during a process of desorbing the lithium ion from the lithium manganese oxide by the reaction of the lithium manganese oxide and the acid solution, which are injected into the acid-resistant water bath, to generate the manganese oxide, thereby easily increasing the reaction rate of the acid solution with the lithium manganese oxide.

### DESCRIPTION OF DRAWINGS

FIG. 1 is a schematic diagram of a sea water lithium-recovery device using coastal-water-based lithium-adsorption equipment and shore-based lithium-isolation equipment according to an exemplary embodiment of the present invention and is a schematic diagram of a form in which a portion to which lithium is adsorbed moves to supply the adsorbed lithium.

FIG. 2 is a schematic diagram illustrating another form of the sea water lithium-recovery device using coastal-water-based lithium-adsorption equipment and shore-based lithium-isolation equipment according to an exemplary embodiment of the present invention and is a schematic diagram of a form having a high-concentration lithium solution preparing means.

FIG. 3 is a schematic diagram for describing an example of a lithium-adsorption means that is a component of the present invention.

FIG. 4 is a schematic diagram for describing an arrangement structure of a first electrode and a second electrode of the lithium-adsorption means that is the component of the present invention (state in which the first electrode and the second electrode are alternately disposed at a predetermined interval and an insulating layer is disposed between the first electrode and the second electrode).

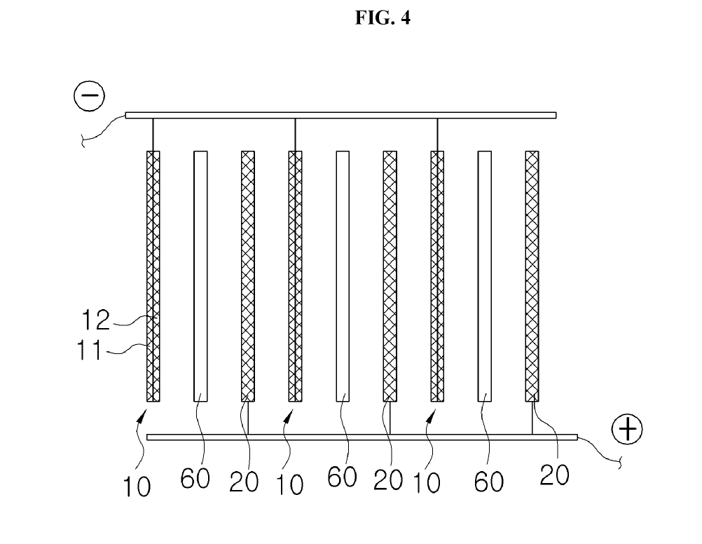

FIG. 5 is another schematic diagram for describing the arrangement structure of the first electrode and the second electrode of the lithium-adsorption means that is the component of the present invention (state in which the first electrode is disposed in plural and one second electrode for the plurality of first electrodes is disposed).

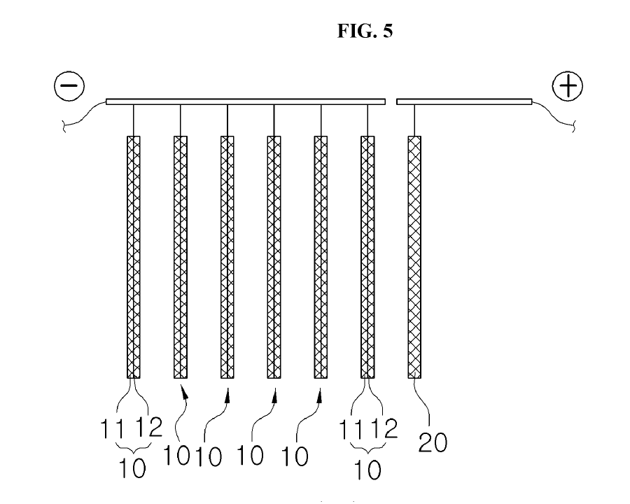

FIG. 6 is a schematic diagram illustrating a structure in which the first electrode and the second electrode that are metal electrodes of which both surfaces are coated with a manganese oxide adsorbent are repeatedly disposed.

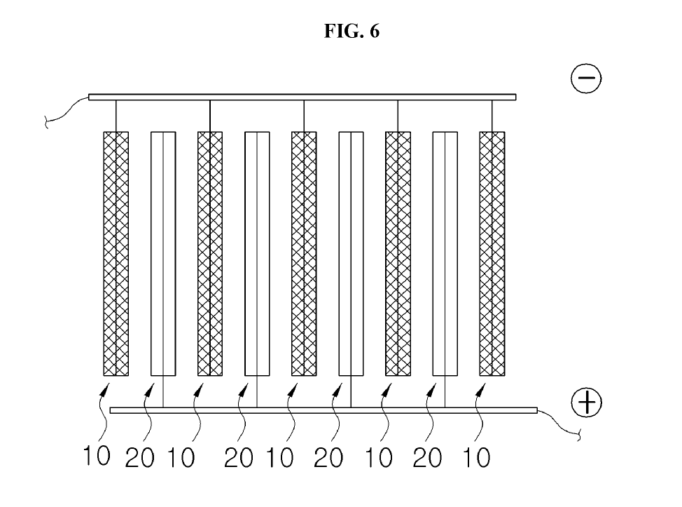

FIG. 7 is a perspective view of a lithium-recovery station according to an exemplary embodiment of the present invention.

FIG. 8 is a plan view of the lithium-recovery station according to the exemplary embodiment of the present invention.

FIG. 9 is a side view of the lithium-recovery station according to the exemplary embodiment of the present invention.

FIG. 10 is a perspective view of a lithium-desorption device using aeration according to an exemplary embodiment of the present invention.

FIG. 11 is a cross-sectional view of an aeration means according to an exemplary embodiment of the present invention.

FIG. 12 is a perspective view of a lithium-desorption device using aeration according to another exemplary embodiment of the present invention.

FIG. 13 is a graph illustrating extractability in which acid solution is desorbed from lithium manganese oxide by a reaction of the lithium manganese oxide with the acid solution on the basis of an experimental example of the lithium-desorption device using aeration according to the exemplary embodiment of the present invention.

### BEST MODE

Hereinafter, a technical spirit of the present invention will be described in more detail with reference to the accompanying drawings.

However, the accompanying drawings are only examples shown in order to describe the technical idea of the present invention in more detail. Therefore, the technical idea of the present invention is not limited to shapes of the accompanying drawings.

The present invention relates to a sea water lithium-recovery device and a lithium-recovery station using coastal-water-based lithium-adsorption equipment and shore-based lithium-isolation equipment and a lithium desorption device using aeration.

In this case, the present invention may apply a lithium-recovery station to a lithium adsorption means of the sea water lithium-recovery device using coastal-water-based lithium-adsorption equipment and shore-based lithium-isolation equipment.

Further, the present invention may apply a lithium-desorption device using aeration to a lithium-isolation means of the sea water lithium-recovery device using coastal-water-based lithium-adsorption equipment and shore-based lithium-isolation equipment.

Hereinafter, a sea water lithium-recovery device using coastal-water-based lithium-adsorption equipment and shore-based lithium-isolation equipment according to an exemplary embodiment of the present invention will be described.

### Sea Water Lithium-Recovery Device Using Coastal-Water-Based Lithium-Adsorption Equipment and Shore-Based Lithium-Isolation Equipment According to the Present Invention

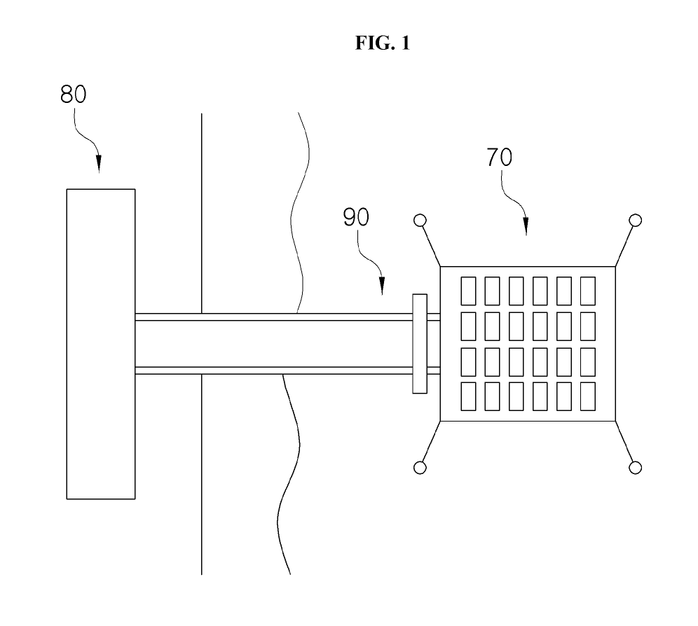

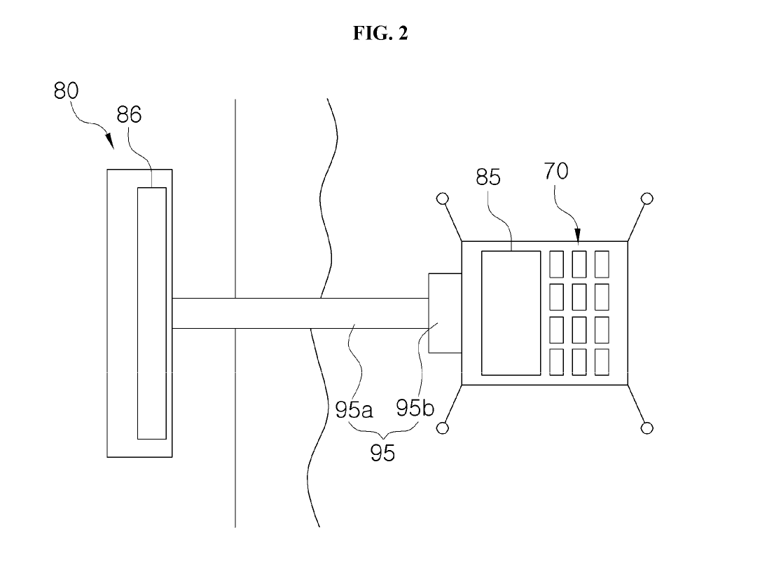

FIG. 1 is a schematic diagram of a sea water lithium-recovery device using coastal-water-based lithium-adsorption equipment and shore-based lithium-isolation equipment according to an exemplary embodiment of the present invention and is a schematic diagram of a form in which a portion to which lithium is adsorbed moves to supply the adsorbed lithium and FIG. 2 is a schematic diagram illustrating another form of the sea water lithium-recovery device using coastal-water-based lithium-adsorption equipment and shore-based lithium-isolation equipment according to an exemplary embodiment of the present invention and is a schematic diagram of a form having a high-concentration lithium solution preparing means.

As illustrated in FIGS. 1 and 2, the sea water lithium-recovery device using coastal-water-based lithium-adsorption equipment and shore-based lithium-isolation equipment according to an exemplary embodiment of the present invention has a lithium-adsorption means 70 adsorbing lithium included in sea water.

Further, the sea water lithium-recovery device includes a lithium-isolation means 80 obtaining lithium by isolating the lithium adsorbed to the lithium-adsorption means 70.

The lithium-adsorption means 70 or the lithium-isolation means 80 are already known in various forms, and therefore a detailed description thereof will be omitted.

By the way, the present invention is to provide the sea water lithium-recovery device having more excellent economical efficiency, long driving time owing to less effect of weather conditions, and more excellent safety.

The inventors of the present application devise a structure in which a lithium adsorption process adsorbing lithium from sea water is performed at the coast having weather conditions relatively better than those of the ocean and a process of recovering the adsorbed lithium moves to the coast to be performed at the coast.

Therefore, the lithium-adsorption means 70 is positioned at the coast to adsorb the lithium included in the sea water.

Further, the lithium-isolation means 80 is positioned at the shore and isolates the lithium adsorbed to the lithium-adsorption means 70 to obtain lithium.

As such, according to the present invention, the adsorption of lithium is performed at the coast and the recovery of lithium is performed at the shore.

Therefore, according to the present invention, the sea water lithium-recovery device has an adsorbed lithium moving means 90 moving a portion to which the lithium is adsorbed in the lithium-adsorption means 70 to the lithium-isolation means 80 to supply the adsorbed lithium.

The portion to which the lithium is adsorbed may be electrode having a carrier of which the surface is coated with an adsorbent including manganese oxide

That is, the electrode to which the lithium is adsorbed in the lithium-adsorption means 70 may be supplied to the lithium-isolation means 80 of the shore.

The adsorbed lithium moving means 90 may move the lithium adsorbent to which the lithium is adsorbed along a line and supply the lithium adsorbent to the lithium-isolation means 80.

A process of isolating and moving the portion to which the lithium is adsorbed by the lithium-adsorption means 70 may be performed manually and may also be automatically or semi-automatically performed by a robot, etc.

The foregoing structure is a structure in which the portion to which the lithium is adsorbed is supplied from the coast to the shore.

The foregoing structure may minimize the number of processes performed at the coast, but consume a lot of costs to implement the adsorbed lithium moving means 90.

To solve the disadvantages, the present invention proposes a structure of preparing a high-concentration lithium containing solution at the coast and supplying the high-concentration lithium containing solution to the coast shore a pipe to extract and recover the lithium at the shore.

Describing in detail the structure, the structure includes the lithium-adsorption means 70 positioned at the coast to adsorb the lithium included in sea water.

Further, the structure includes the high-concentration lithium solution preparing means 85 positioned at the coast and isolating the lithium adsorbed to the lithium-adsorption means 70 to be a high-concentration lithium containing solution.

Further, the structure includes a lithium-extraction means 86 positioned at the shore and supplied with the high-concentration lithium solution obtained by the high-concentration lithium solution preparing means 85 at the coast to extract lithium.

Further, the structure includes a lithium solution supply means 95 supplying the high concentration lithium solution obtained by the high-concentration lithium solution preparing means 85 to the lithium-extraction means 86.

The high-concentration lithium solution preparing means 85 may be implemented to isolate the lithium by a method of isolating the adsorbed lithium using chemicals such as hydrochloric acid, a method for changing polarity of electricity, etc., and include the isolated lithium in a solution to thereby form the high-concentration lithium containing solution.

The lithium-extraction means 86 may be implemented to prepare high-purity lithium and various kinds of lithium compounds by the known chemical processing process, etc.

The lithium solution supply means 95 may be implemented to include a supply pipe 95a connecting between the high-concentration lithium solution preparing means 85 and the lithium-extraction means 86 and a pump 95b supplying the high-concentration lithium solution to the supply pipe 95a.

The structure in which the high-concentration lithium solution is prepared at the coast and supplied to the shore through the supply pipe 95a and the pump 95b to extract lithium has an advantage in which costs taken to connect between the coast and the shore are less consumed.

In particular, when topography from the coast to the shore is flat, it is easy to install the supply pipe 95a, and therefore economical efficiency is more improved.

In the present invention, there is a need to make the adsorption efficiency of the lithium-adsorption means 70 excellent.

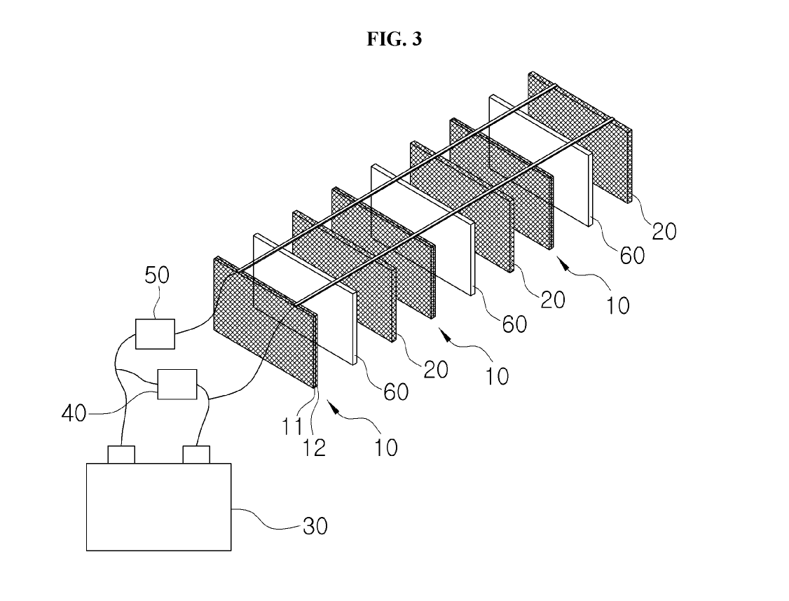

For this purpose, the lithium-adsorption means 70 may be implemented in the form as illustrated in FIG. 3.

In FIG. 3, the lithium-adsorption means includes a first electrode 10 having the carrier 11 of which the surface is coated with the adsorbent 12 including manganese oxide.

Further, the lithium-adsorption means includes a second electrode 20 dipped in the sea water including lithium, disposed to face the first electrode 10 at a predetermined interval, and applied with electricity.

Further, the lithium-adsorption means includes a power supplier 30 applying electricity to the first electrode 10 and the second electrode 20 and applying a negative electrode (−electrode) and a positive electrode (+electrode) to the first electrode 10 and the second electrode 20, respectively.

By the structure, lithium ion may be quickly and deeply diffused into the adsorbent 12 and substituted with hydrogen ion to be adsorbed.

Further, the structure may be large and have excellent energy efficiency and economical efficiency.

In this structure, the high-concentration lithium solution preparing means 85 may be implemented to change polarity of electricity applied to the first electrode 10 and the second electrode 20 to apply a positive electrode (+electrode) to the first electrode 10 and a negative electrode (−electrode) to the second electrode 20.

In this case, the high-concentration lithium solution may be an acidic solution in which an acid concentration of a desorption solution used upon the desorption of the adsorbed lithium is thin and therefore the adsorbent may be repeatedly used for a long period of time.

That is, the high-concentration lithium solution is prepared by changing the polarity of electricity applied to the first electrode 10 and the second electrode 20 in the state in which the first electrode 10 and the second electrode 20 are dipped in the thin acidic solution to isolate lithium.

In the present invention, the structure may further include the lithium-adsorption means 70 positioned at the coast or a fresh water supply means supplying fresh water to equipment therearound.

The fresh water may be used in a washing operation, etc.

The fresh water supply means may be implemented to include a fresh water supply pipe and a supply pump connecting between the coast and the shore.

Non-explained reference numeral 40 is a voltmeter, non-explained reference numeral 50 is ammeter, and non-explained reference numeral 60 is an insulating layer.

Hereinafter, the lithium-recovery station according to the exemplary embodiment of the present invention will be described.

### Lithium-Recovery Station According to the Present Invention

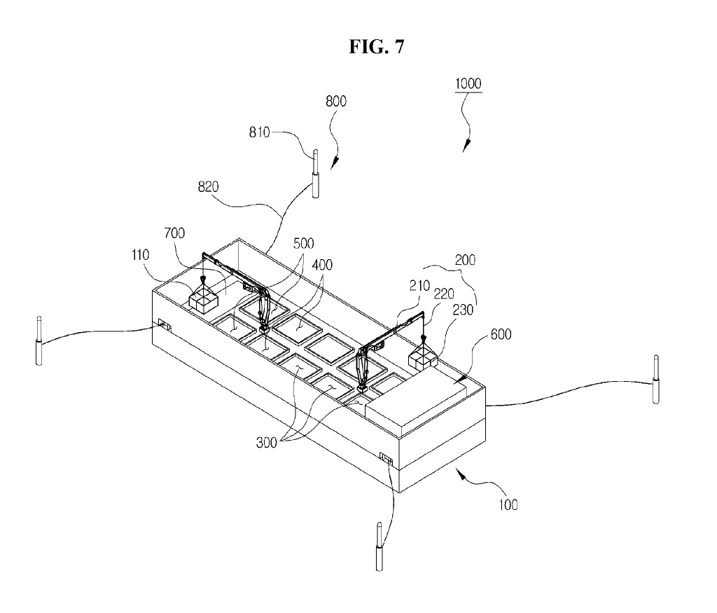

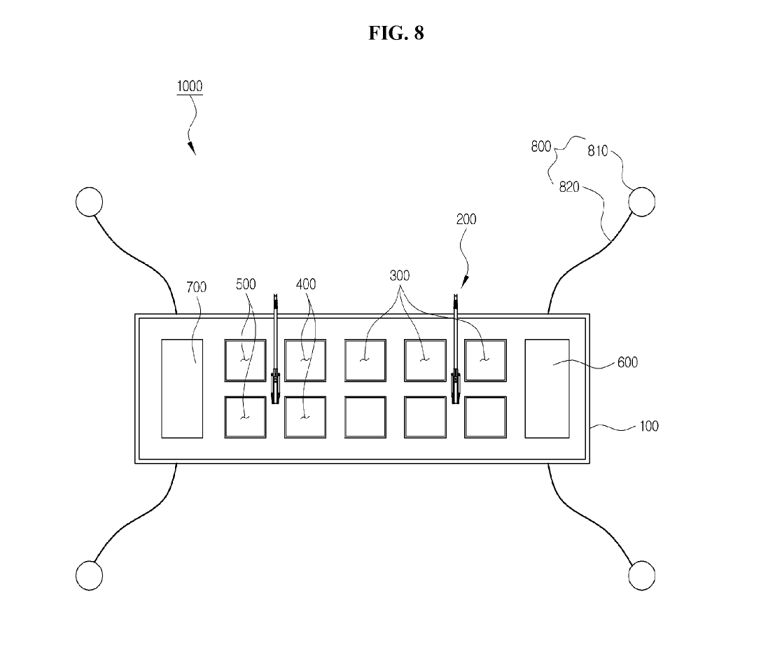

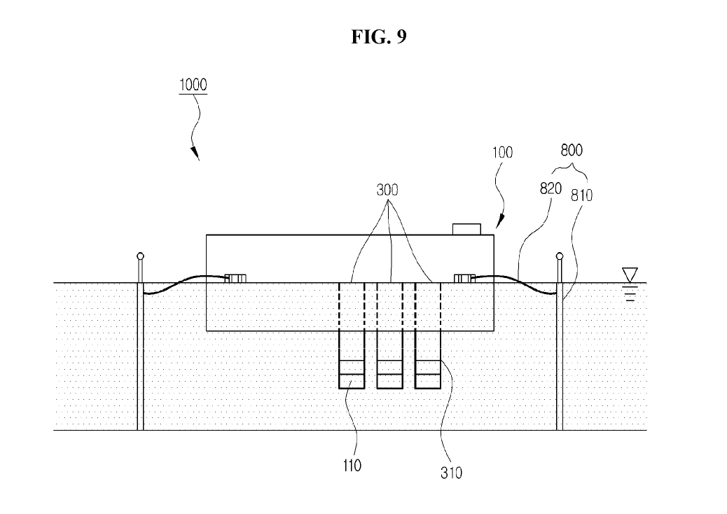

FIG. 7 is a perspective view of a lithium-recovery station according to an exemplary embodiment of the present invention, FIG. 8 is a plan view of the lithium-recovery station according to the exemplary embodiment of the present invention, and FIG. 9 is a side view of the lithium-recovery station according to the exemplary embodiment of the present invention.

As illustrated in FIGS. 7 to 9, a lithium-recovery station 1000 according to an exemplary embodiment of the present invention may include a floater 100, a moving means 200, an adsorption bath 300, a cage 310, a washing bath 400, and a desorption bath 500.

The floater 100 is installed on the sea and may be formed in a plate form.

In this case, the floater 100 may have a form of powerless ships such as a barge or a lower portion of the floater 100 may be formed of a floating material and an upper portion thereof may be formed in a quadrangular box form but the present invention is not limited thereto.

The moving means 200 is installed on an upper surface of the floater 100 and serves to move a lithium adsorbent 110 to the adsorption bath 300, the washing bath 400, and the desorption bath 500, respectively.

Here, as the lithium adsorbent 110, a high selective lithium adsorbent 110 that may adsorb lithium by an ion exchange may be used and the lithium adsorbent 110 may be manganese oxide.

In this case, as the manganese oxide, a spinel type manganese oxide, in particular, a spinel type manganese oxide having a three-dimensional tunnel structure is preferable, manganese oxide represented by a chemical formula HnMn₂₋ₓO₄ (In the chemical formula, 1≦n≦1.33, 0≦x≦0.33, n≦1+x) is more preferable, and H_{1.33}Mn_{1.67}O₄ is most preferable, but the manganese oxide is not limited thereto. Therefore, modified manganese oxide such as H_{1.6}Mn_{1.6}O₄ having more improved performance may be applied to the present invention.

Further, a surface of the manganese oxide may be formed with a plurality of dimples to adsorb lithium ion.

The adsorption bath 300 is installed on a lower surface of the floater 100 and penetrates through the lower surface of the floater 100 and has upper and lower surfaces opened to contact with sea water on the sea. Accordingly, the lithium adsorbent 110 is exposed to the sea water on the sea positioned at the lower portion of the adsorption bath 300 while passing through the upper and lower surfaces of the adsorption bath 300 by the moving means 200 and thus the lithium ion included in the sea water on the sea is adsorbed to the lithium adsorbent 110.

That is, the adsorption bath 300 does not forcibly introduce the sea water on the sea into the lithium adsorbent 110 and exposes the lithium adsorbent 110 to the sea water on the sea to induce a lithium adsorption reaction.

The cage 310 is coupled to the lower surface of the adsorption bath 300 to be positioned at the sea water on the sea and the lithium adsorbent 110 passing through the upper and lower surfaces of the adsorption bath 300 is stacked.

The cage 310 may be formed in a frame 230 shape and serves to prevent the lithium adsorbent 110 passing through the upper and lower surfaces of the adsorption bath 300 from contacting a sea ground.

Further, the cage 310 may be preferably made of stainless steel to be maximally prevented from corroding due to the sea water on the sea.

The washing bath 400 is installed on the upper surface of the floater 100 and has an upper surface opened and a washing solution accommodated therein to wash the lithium adsorbent 110 to which the lithium ion moving from the adsorption bath 300 by the moving means 200 is adsorbed.

In this case, the washing bath 400 serves to wash sea salt and impurities that get on the lithium adsorbent 110 to which the lithium ion is adsorbed.

The desorption bath 500 is installed on the upper surface of the floater 100 and has the upper surface opened to serve to desorb the lithium ion of the lithium adsorbent 110 to which the lithium ion moving from the washing bath 400 by the moving means 200 is adsorbed.

In this case, the desorption bath 500 may recover a liquid including the lithium ion desorbed from the lithium adsorbent 110.

According to the exemplary embodiment of the present invention, the lithium-recovery device may include: a floater floating on the sea; a moving means installed in the floater to move the lithium adsorbent 110; an adsorption bath installed in the floater, having a lower surface opened to contact with sea water, and adsorbing lithium ion in the state in which the lithium adsorbent 110 is dipped in the sea water of a lower surface of the floater; a cage coupled to the lower surface of the adsorption bath and stacking the lithium adsorbent 110 in the state in which the lithium adsorbent 110 is dipped in the sea water; a washing bath installed in the floater and washing the lithium adsorbent 110 to which the lithium ion moving from the adsorption bath by the moving means is adsorbed; and a desorption bath installed in the floater and desorbing the lithium ion of the lithium adsorbent 110 to which the lithium ion moving from the washing bath by the moving means is adsorbed, thereby removing a necessity of power for introducing the sea water to maximally reduce the power required to recover the lithium included in the sea water.

Meanwhile, the floater 100 may further include a washing solution storage tank (not illustrated) storing a washing solution supplied to the washing bath 400 and a lithium desorption solution storage tank (not illustrated) storing a lithium desorption solution desorbed in the desorption bath 500.

In this case, the washing solution storage tank and the lithium desorption solution storage tank may each be installed in the floater 100.

Meanwhile, the lithium desorption solution storage tank may store a solution including the lithium desorption solution desorbed in the desorption bath 500. In this case, the desorption bath 500 may be stored with a predetermined amount of solution to include the lithium ion.

Further, the floater 100 may further include a lithium ion transfer means (not illustrated) supplying the lithium desorption solution desorbed in the desorption bath 500 to the shore or a land adjacent to the shore.

In this case, the lithium ion transfer means may be formed of a first connection pipe connecting between the desorption bath 500 and the shore or the desorption bath 500 and the land adjacent to the shore.

Further, the floater 100 may further include a washing solution transfer means (not illustrated) supplying a washing solution required for the washing bath 400 from the shore or the land adjacent to the shore.

The washing solution transfer means may include a second connection pipe connecting between a washing solution storage box (not illustrated) positioned at the shore and the desorption bath 500 or a washing solution storage box (not illustrated) positioned at the land adjacent to the shore and the desorption bath 500.

Meanwhile, the moving means 200 may include a crane 210, a chain 220, and a frame 230.

The crane 210 is installed on the upper surface of the floater 100 and may be vertically rotated based on a rotating shaft.

The chain 220 is connected to the crane 210 and a length of the chain 220 may be controlled in a length direction. The chain 220 may be formed in a band shape.

In this case, the crane 210 may be coupled to a first fastening ring (not illustrated) so that one surface thereof is locked with the chain 220.

The frame 230 is connected to the chain 220 and has the manganese oxide received therein.

In this case, the frame 230 may be coupled to a second fastening ring (not illustrated) so that one surface thereof is locked with the chain 220.

Further, the lithium-recovery station 1000 may further include a power generator 600 such as diesel power generation and solar heat and a storage bath 700.

The power generator 600 is installed on the upper surface of the floater 100 and serves to produce power using diesel power generation and solar heat and supply the produced power to lighting apparatuses of the crane 210 and the floater 100 and a cooler and a heater of a cabin.

The power generator 600 is a deck and an upper portion thereof may be provided with a solar panel producing power using solar heat.

The storage bath 700 is installed on the upper surface of the floater 100 is stored with the lithium desorption solution desorbed in the desorption bath 500.

The lithium ion stored in the storage bath 700 is stored in an ion state or an aqueous solution state and may be supplied to the ground.

Further, the lithium-recovery station 1000 may further include a support means 800 for fixing the floater 100 to the sea ground.

The support means 800 may include a pillar 810 and a connection rope 820.

The pillar 810 is fixed to the sea ground positioned around the floater 100.

The connection rope 820 connects between the pillars 810 and the floater 100.

Therefore, the floater 100 may move only within a predetermined range by the support means 800.

Hereinafter, a lithium-desorption device using aeration according to an exemplary embodiment of the present invention will be described.

### Lithium-Desorption Device Using Aeration According to the Present Invention

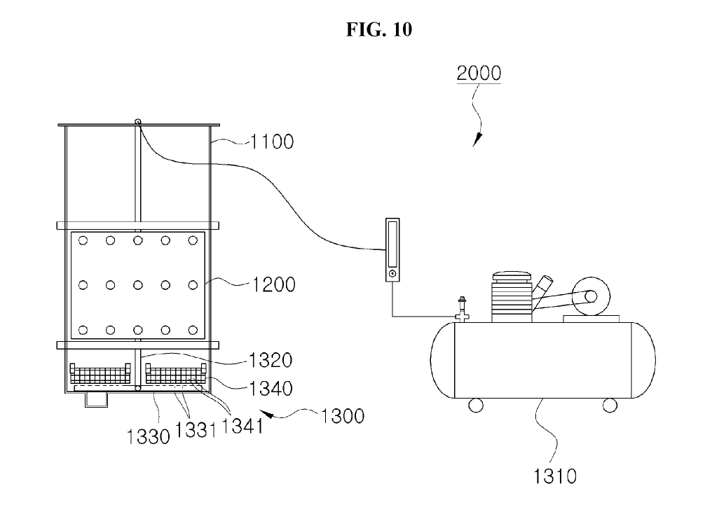

FIG. 10 is a perspective view of a lithium-desorption device using aeration according to an exemplary embodiment of the present invention.

As illustrated in FIG. 10, a lithium-desorption device 2000 using aeration according to an exemplary embodiment of the present invention may include a housing 1100, a lithium reaction body 1200, and an aeration means 1300.

The housing 1100 may be formed in a rectangular parallelepiped shape in which the upper surface is opened and has an acid solution stored therein.

In this case, the acid solution may be a hydrochloric acid (HCI) solution of 0.5 mol or less.

Further, the housing 1100 may be formed of any material having chemical resistance that is not dissolved in water and does not react to acid, in particular, weak acid and excellent mechanical strength that may maintain a size of pore without limitation and a polymer material according to the exemplary embodiment of the present invention may be used. An example of the polymer material may include one or more selected from the group consisting of polysulfone, polyethersulfone, polyethylene, polypropylene, polyvinylchloride, a mixture thereof, and copolymer thereof, but the present invention is not limited thereto.

A first process of inserting a lithium reaction body 1200 having an outer wall made of a porous polymer member and the lithium manganese oxide stored therein into the housing 1100 to desorb lithium ion from the lithium manganese oxide by the reaction of the lithium manganese oxide stored in the lithium reaction body with the acid solution to generate the manganese oxide, a second process of inserting the lithium reaction body 1200 into the sea water to adsorb the lithium ion included in the sea water to the manganese oxide by the reaction of the manganese oxide generated in the first process with the sea water to again generate the lithium manganese oxide, and a third process of again inserting the lithium reaction body 1200 into the housing 1100 to desorb the lithium ion from the lithium manganese oxide by the reaction of the manganese oxide generated in the second process with the acid solution to generate the manganese oxide are performed.

In this case, the outer wall of the lithium reaction body 1200 may be formed of a porous polymer membrane to perform the coming in and discharge of the acid solution and the sea water without pressure from the outside.

Further, the lithium reaction body 1200 may be formed of a polymer material having excellent chemical resistance against the sea water and the acid solution and excellent mechanical strength that may constantly maintain the size of the pore.

Further, the lithium manganese oxide stored in the lithium reaction body 1200 is the spinel type lithium manganese oxide, preferably, the spinel type lithium manganese oxide having the 3-dimensional tunnel structure and may depend on the following Chemical Formulas 1 and 2.

LiₐMn_{2-b}O₄ [Chemical Formula 1]

(however, 1≦a≦1.33, 0≦b≦0.33, a≦1+b)

Li_{1.6}Mn_{1.6}O₄ [Chemical Formula 2]

The aeration means 1300 is to increase the reaction rate of the lithium manganese oxide positioned in the housing 1100 with the acid solution and includes an air supply means 1310, a first air pipe 1320, a second air pipe 1330, and an aeration box 1340.

The air supply means 1310 is installed outside the housing 1100 and is a known air compressor generating compressed air and therefore a detailed description thereof will be omitted.

The first air pipe 1320 is a connection pipe connected to the air supply means 1310 and may extend from the upper surface of the housing 1100 to the lower surface thereof.

The second air pipe 1330 is connected to the first air pipe 1320 and is provided with a perforation 1331 that is installed at a bottom surface in the housing 1100 to inject air into the upper surface thereof.

In this case, the air supplied from the air supply means 1310 is injected into the perforation 1330.

The aeration box 1340 is installed in the housing 110 to face the perforation 1331 and includes a plurality of pores 1341 uniformly splitting the air supplied from the air supply means 1310.

In this case, the aeration box 1340 is preferably installed at a lower portion in the housing 1100 so that the air may maximally stay in the housing 1100 in consideration of the fact that the air injected through the pores 1341 rises by natural convection.

According to the exemplary embodiment of the present invention, the lithium-desorption device 2000 using aeration may inject air to the acid solution and the lithium manganese oxide using the aeration means 1300 even when the weight of the lithium manganese oxide is very heavy, during a process of desorbing the lithium ion from the lithium manganese oxide by the reaction of the lithium manganese oxide and the acid solution, which are injected into the acid-resistant water bath, to generate the manganese oxide, thereby easily increasing the reaction rate of the acid solution with the lithium manganese oxide.

Meanwhile, the plurality of aeration boxes 1340 may be arranged at the lower portion in the housing 1100.

Hereinafter, an example of the aeration means according to the present invention will be described.

### Aeration Means—Example

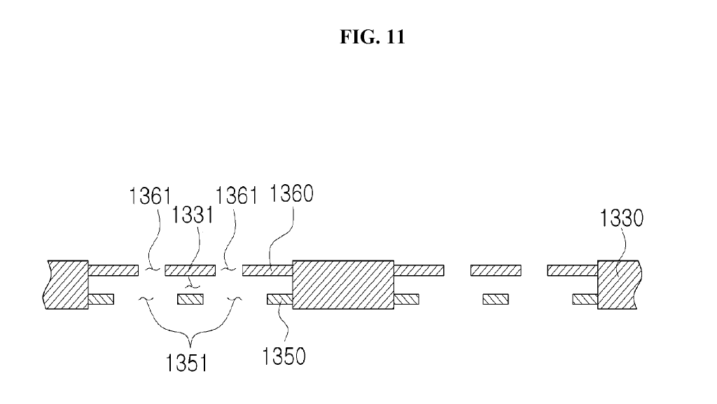

FIG. 11 is a cross-sectional view of an aeration means according to an exemplary embodiment of the present invention.

As illustrated in FIG. 11, the aeration means 1300 according to the exemplary embodiment of the present invention may further include a first air deck 1350 and a second air deck 1360.

The first air deck 1350 is installed in the perforation 1331 and is provided with a plurality of first split holes 1351 that split the air supplied from the air supply means 1310 to the perforation 1331 at a uniform size and inject the air into the pore 1341.

The first split holes 1351 are formed by perforating predetermined areas of the first air deck 1350, respectively, and may be formed in a circle or an oval.

The second air deck 1360 is installed in the perforation 1331 and is installed to be spaced apart from the first air deck 1350 at a predetermined interval in an air injection direction of the perforation 1331 and is provided with a plurality of second split holes 1361 again splitting air passing through the first split holes 1351 at a uniform size.

In this case, while the air split at a uniform size while passing through the first split holes 1351 is again split at a uniform size while passing through the second split holes 1361, the air is injected into the housing 1100 through the pores 1341 while being again split at a uniform size to have a uniform size of flowing force in each predetermined area in the housing 1100.

Therefore, in the aeration means 1300 according to the exemplary embodiment oft the present invention, the air injected into the housing 1100 has a uniform size of flowing force in each predetermined area in the housing 1100 and thus the reaction rate of the acid solution with the lithium manganese oxide is uniform in each predetermined area in the housing 1100.

### Lithium-Desorption Device Using Aeration According to the Present Invention

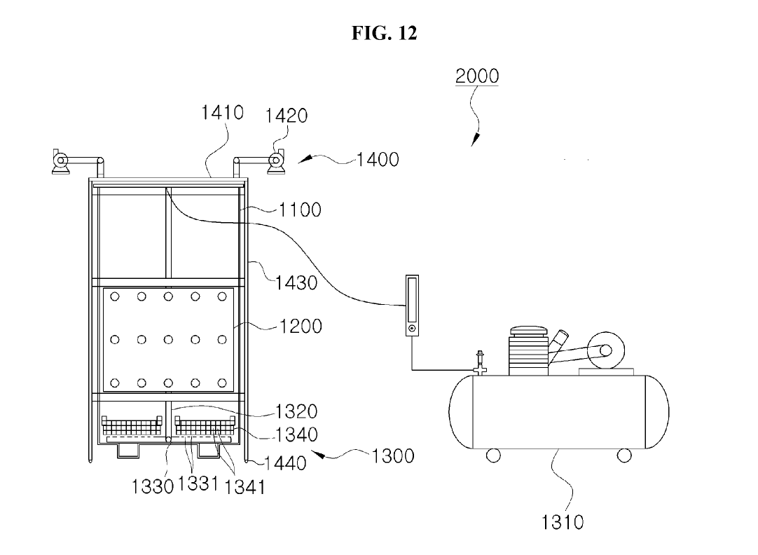

FIG. 12 is a perspective view of a lithium-desorption device using aeration according to another exemplary embodiment of the present invention.

As illustrated in FIG. 12, the lithium-desorption device 2000 using aeration according to an exemplary embodiment of the present invention includes a top cover 1410, a blower 1420, a support 1430, and a wheel 1440.

The top cover 1410 covers the opened upper surface of the housing 1100 and serves to block the lithium ion generated by the reaction of the lithium manganese oxide with the acid solution in the housing 1100 from being discharged to the outside.

The blower 1420 penetrates through the upper surface of the top cover 1410 to suck the lithium ion generated in the housing 1100.

The support 1430 is coupled to a lower end of a circumferential surface of the top cover 1410 and encloses the circumferential surface of the housing 1100 to serve to support the housing 1100.

The wheel 1440 is coupled to the lower end of the support 1430 to serve to freely move the housing 1100 and the air duct 1400.

The lithium-desorption method using the lithium-desorption device using aeration according to the exemplary embodiment of the present invention includes a first process of inserting a lithium reaction body into the housing to desorb the lithium ion from the lithium manganese oxide by the reaction of the lithium manganese oxide stored in the lithium reaction body with the acid solution to generate the manganese oxide and increasing the reaction rate of the lithium manganese oxide with the acid solution by air injected through pores of the aeration box; and a second process of inserting the lithium reaction body 1200 into the sea water to adsorb the lithium ion included in sea water to the manganese oxide by the reaction of the manganese oxide generated in the first process with the sea water to again generate the lithium manganese oxide.

That is, the reaction rate of the lithium manganese oxide stored in the lithium reaction body with the acid solution is increased by the air injected through the pores of the aeration box.

Further, the lithium-desorption method may further include a third process of again inserting the lithium manganese oxide generated in the second process into a housing to desorb the lithium ion from the lithium manganese oxide by the reaction of the lithium manganese oxide stored in the lithium reaction body with the acid solution to generate the manganese oxide and increasing the reaction rate of the lithium manganese oxide with the acid solution by air injected through pores of the aeration box.

That is, the reaction rate of the lithium manganese oxide stored in the lithium reaction body with the acid solution is again increased by the air injected through the pores of the aeration box.

Typically, to increase the reaction rate of the lithium manganese oxide with the acid solution, there is a method for applying a magnetic filed to an acid-resistant water bath. The existing method may not be used when the weight of the lithium reaction body is very heavy in a ton unit.

However, the lithium-desorption method according to the exemplary embodiment of the present invention increases the reaction rate of the lithium manganese oxide stored in the lithium reaction body with the acid solution using the air injected through the pores of the aeration box to easily increase the reaction rate of the lithium manganese oxide stored in the lithium reaction body with the acid solution even when the weight of the lithium reaction body is very heavy in a ton unit.

Hereinafter, an experimental example of the present invention will be described.

### Experimental Example

A factor of affecting the efficiency of the lithium-desorption process may be the concentration of the acid solution received in the housing 1100 and the concentration of the lithium concentrated in the acid solution.

In particular, as long as a large amount of lithium may be concentrated by repeatedly using the acid solution at a level where the concentration of the acid solution is maintained to be low and the efficiency of the desorption reaction is not reduced, the efficiency of the lithium desorption may be increased.

Further, in the lithium-desorption process, it is important to secure a physical driving force for smoothing the reaction of the acid solution with the lithium reaction body 1200.

In the lithium-desorption device 2000 using aeration according to the exemplary embodiment of the present invention, 800L (or 1600L) of a hydrochloric acid solution of 0.3 mol was injected into the housing 1100, 8 kg (or 16 kg) of lithium manganese oxide as the lithium reaction body 1200 was inserted, air was injected into the housing 1100 using the aeration means 1300, and then extractability of lithium and manganese ion from the lithium manganese oxide by the reaction of the lithium manganese oxide and the acid solution injected into the housing 1100 was measured.

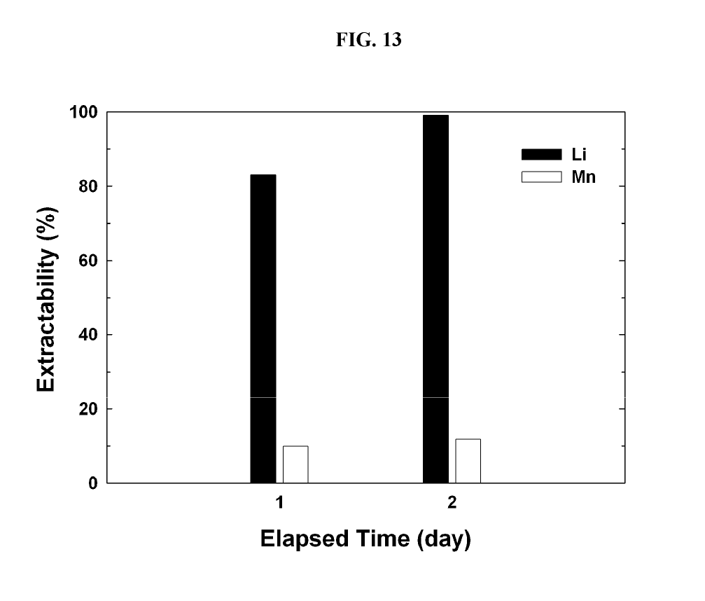

FIG. 13 is a graph illustrating extractability in which lithium and manganese ion are extracted from lithium manganese oxide by a reaction of the lithium manganese oxide with the acid solution on the basis of an experimental example of the lithium-desorption device using aeration according to the exemplary embodiment of the present invention.

As illustrated in FIG. 13, after 1 day, the extractability of lithium ion was shown as about 80% and the extractability of manganese ion was shown as 10% and after 2 days, the extractability of lithium ion was shown as about 95% and the extractability of manganese ion was shown as 20%.

In the case of the manganese oxide to which the lithium ion is adsorbed instead of the lithium manganese oxide as the lithium reaction body 1200, if the reaction time is short as about 2 to 3 hours, more than 95% of lithium may be desorbed.

Therefore, it may be appreciated that the extractability of the lithium ion of the lithium-desorption device 2000 using aeration according to the exemplary embodiment of the present invention is very efficient.

The present invention is not limited to the above-mentioned exemplary embodiments, and may be variously applied, and may be variously modified without departing from the gist of the present invention claimed in the claims.

### DETAILED DESCRIPTION OF MAIN ELEMENTS

10: First electrode
11: Carrier
12: Adsorbent
20: Second electrode
30: Power supplier
40: Voltmeter
50: Ammeter
60: Insulating layer
70: Lithium-adsorption means
80: Lithium-isolation means
85: High-concentration lithium solution preparing means
86: Lithium extraction means
90: Adsorbed lithium moving means
95: Lithium solution supply means
95a: Supply pipe
95b: Pump
1000: Lithium-recovery station according to the present invention
100: Floater
110: Lithium adsorbent
200: Moving means
210: Crane 220: Chain
230: Frame
300: Adsorption bath
310: Cage
400: Washing bath
500: Desorption bath
600: Power generator
700: Storage bath
800: Support means
810: Pillar
820: Connection rope
2000: Lithium-desorption device according to the present invention
1100: Housing
1200: Lithium reaction body
1300: Aeration means
1310: Air supply means
1320: First air pipe
1330: Second air pipe
1331: Perforation
1340: Aeration box
1341: Pore
1350: First deck
1351: First split hole
1360: Second deck
1361: Second split hole
1400: Air duct
1410: top cover
1420: Blower
1430: Support bar
1440: Wheel

1. A sea water lithium-recovery device using coastal-water-based lithium-adsorption equipment and shore-based lithium-isolation equipment for recovering lithium included in sea water, comprising:
a lithium-adsorption means 70 positioned at a coast to adsorb the lithium included in the sea water;
a lithium-isolation means 80 positioned at a shore or a land adjacent to the shore and isolating the lithium adsorbed to the lithium-adsorption means 70 to obtain the lithium; and
an adsorbed lithium moving means 90 moving a portion to which the lithium is adsorbed in the lithium-adsorption means 70 to the lithium-isolation means 80 to supply the adsorbed lithium.

2. The sea water lithium-recovery device of claim 1, wherein the adsorbed lithium moving means 90 moves a lithium adsorbent to which the lithium is adsorbed along a line and supplies the lithium adsorbent to the lithium-isolation means 80.

3. A lithium-recovery device using coastal-water-based lithium-adsorption equipment and shore-based lithium-isolation equipment for recovering lithium included in sea water, comprising:
a lithium-adsorption means 70 positioned at a coast to adsorb the lithium included in the sea water;
a high-concentration lithium solution preparing means 85 positioned at the coast and isolating the lithium adsorbed to the lithium-adsorption means 70 to be a high-concentration lithium containing solution;
a lithium-extraction means 86 positioned at a shore or a land adjacent to the shore and supplied with the high-concentration lithium solution obtained by the high-concentration lithium solution preparing means 85 to extract the lithium; and
a lithium solution supply means 95 supplying the high-concentration lithium solution obtained by the high-concentration lithium solution preparing means 85 to the lithium-extraction means 86.

4. The sea water lithium-recovery device of claim 3, wherein the lithium solution supply means 95 includes a supply pipe 95a connecting between the high-concentration lithium solution preparing means 85 and the lithium-extraction means 86 and a pump 95b supplying the high-concentration lithium solution to the supply pipe 95a.

5. The sea water lithium-recovery device of claim 1, wherein the lithium-adsorption means 70 includes:
a first electrode 10 having a carrier 11 of which the surface is coated with an adsorbent 12 including manganese oxide;
a second electrode 20 dipped in the sea water including the lithium, disposed to face the first electrode 10 at a predetermined interval, and applied with electricity; and
a power supplier applying electricity to the first electrode 10 and the second electrode 20 and applying a negative electrode (−electrode) and a positive electrode (+electrode) to the first electrode 10 and the second electrode 20, respectively.

6. A lithium-recovery station 1000, comprising:
a floater 100 floating on the sea;
a moving means 200 installed in the floater 100 to move a lithium adsorbent 110;
an adsorption bath 300 installed in the floater 100, having a lower surface opened to contact with sea water to allow the lithium adsorbent 110 to adsorb lithium ion in the state in which the lithium adsorbent 110 is dipped in the sea water of a lower surface of the floater;
a cage 310 coupled to the lower surface of the adsorption bath 300 and stacking the lithium adsorbent 110 in the state in which the lithium adsorbent 110 is dipped in the sea water;
a washing bath 400 installed in the floater 100 and washing the lithium adsorbent 110 to which the lithium ion moving from the adsorption bath 300 by the moving means 200 is adsorbed; and
a desorption bath 500 installed in the floater 100 and desorbing the lithium ion of the lithium adsorbent 110 to which the lithium ion moving from the washing bath 400 by the moving means 200 is adsorbed.

7. The lithium-recovery station 1000 of claim 6, wherein the floater 100 further includes a washing solution storage tank storing a washing solution supplied to the washing bath 400 and a lithium desorption solution storage tank storing a lithium desorption solution desorbed in the desorption bath 500.

8. The lithium-recovery station 1000 of claim 6, wherein the floater 100 further includes a lithium desorption solution transfer means for supplying a lithium desorption solution desorbed in the desorption bath 500 to a shore or a land adjacent to the shore.

9. The lithium-recovery station 1000 of claim 8, wherein the floater 100 further includes a washing solution transfer means supplying the required washing solution to the washing bath 400 from the shore or the land adjacent to the shore.

10. The lithium-recovery station 1000 of claim 6, wherein the moving means 200 includes:
a crane 210 installed in the floater 100;
a chain 220 connected to the crane 210; and
a frame 230 connected to the chain 220 and having the lithium adsorbent 110 received therein.

11. The lithium-recovery station 1000 of claim 6, further comprising:
a power generator 600 installed in the floater 100 and producing power using diesel power generation and solar heat and supplying the produced power to a crane 210.

12. The lithium-recovery station 1000 of claim 6, further comprising:
a support means 800 including a plurality of pillars 810 fixed to a sea ground positioned around the floater 100 and a plurality of connection ropes 820 connecting between the pillars 810 and the floater 100.

13. A lithium-desorption device 2000 using aeration, comprising:
a housing 1100 having an upper surface opened and having an acid solution stored therein;
a lithium reaction body 1200 having an outer wall formed of a porous polymer membrane, having lithium manganese oxide stored therein, and inserted into the housing 1100 to desorb lithium ion from the lithium manganese oxide by a reaction of the lithium manganese oxide with the acid solution to generate manganese oxide; and
an aeration means 1300 including an air supply means 1310 installed at an outer side of the housing 1100, a first air pipe 1320 connected to the air supply means 1310 and installed in the housing 1100, a second air pipe 1330 connected to the first air pipe 1320 and provided with a perforation 1331 that is installed at a bottom surface inside the housing 1100 and has air injected into a surface thereof, and an aeration box 1340 installed in the housing 1100 and including a plurality of pores 1341 through which air transferred from the perforation 1331 is injected.

14. The lithium-desorption device 2000 of claim 13, wherein the aeration box 1340 is installed in the housing 1100 in plural.

15. The lithium-desorption device 2000 of claim 13, wherein in the aeration means 1300, the perforation 1331 formed in the second air pipe 1330 is wider than the pore 1341 formed in the aeration box 1340.

16. The lithium-desorption device 2000 of claim 13, further comprising:
an air duct 1400 including a top cover 1410 installed on the opened upper surface of the housing 1100, a blower 1420 penetrating through an upper surface of the top cover 1410 to suck the lithium ion generated in the housing 1100, a support 1430 coupled to a lower end of a circumferential surface of the top cover 1410, and a wheel 1440 coupled to a lower end of the support 1430.

17. A lithium-desorption method using the lithium-desorption device using aeration of claim 13, comprising:
a first process of inserting the lithium reaction body into the housing to desorb the lithium ion from the lithium manganese oxide by the reaction of the lithium manganese oxide stored in the lithium reaction body with the acid solution to generate the manganese oxide and increasing a reaction rate of the lithium manganese oxide with the acid solution by the air injected through the pores of the aeration box; and
a second process of inserting the lithium reaction body into sea water to adsorb lithium ion included in sea water to the manganese oxide by a reaction of the manganese oxide generated in the first process with the sea water to again generate the lithium manganese oxide.

18. The lithium-desorption method of claim 17, further comprising:
a third process of again inserting the lithium manganese oxide generated in the second process into the housing to desorb the lithium ion from the lithium manganese oxide by the reaction of the lithium manganese oxide stored in the lithium reaction body with the acid solution to generate the manganese oxide and increasing the reaction rate of the lithium manganese oxide with the acid solution by the air injected through the pores of the aeration box.

19. The sea water lithium-recovery device of claim 2, wherein the lithium-adsorption means 70 includes:
a first electrode 10 having a carrier 11 of which the surface is coated with an adsorbent 12 including manganese oxide;
a second electrode 20 dipped in the sea water including the lithium, disposed to face the first electrode 10 at a predetermined interval, and applied with electricity; and
a power supplier applying electricity to the first electrode 10 and the second electrode 20 and applying a negative electrode (−electrode) and a positive electrode (+electrode) to the first electrode 10 and the second electrode 20, respectively.

20. The sea water lithium-recovery device of claim 3, wherein the lithium-adsorption means 70 includes:
a first electrode 10 having a carrier 11 of which the surface is coated with an adsorbent 12 including manganese oxide;
a second electrode 20 dipped in the sea water including the lithium, disposed to face the first electrode 10 at a predetermined interval, and applied with electricity; and
a power supplier applying electricity to the first electrode 10 and the second electrode 20 and applying a negative electrode (−electrode) and a positive electrode (+electrode) to the first electrode 10 and the second electrode 20, respectively.

21. The sea water lithium-recovery device of claim 4, wherein the lithium-adsorption means 70 includes:
a first electrode 10 having a carrier 11 of which the surface is coated with an adsorbent 12 including manganese oxide;
a second electrode 20 dipped in the sea water including the lithium, disposed to face the first electrode 10 at a predetermined interval, and applied with electricity; and
a power supplier applying electricity to the first electrode 10 and the second electrode 20 and applying a negative electrode (−electrode) and a positive electrode (+electrode) to the first electrode 10 and the second electrode 20, respectively.
